(19) United States
(12) Patent Application Publication
(10) Pub. No.: US 2016/0105628 A1
(43) Pub. Date: Apr. 14, 2016

(54) METHOD FOR CONTROLLING AN ELECTRONIC DEVICE WITH AID OF USER INPUT BACK CHANNEL, AND ASSOCIATED APPARATUS AND ASSOCIATED COMPUTER PROGRAM PRODUCT

(71) Applicant: Mediatek Inc., Hsin-Chu (TW)

(72) Inventor: Kuo-Hsiung Huang, New Taipei City (TW)

(21) Appl. No.: 14/711,790

(22) Filed: May 14, 2015

Related U.S. Application Data
(60) Provisional application No. 62/063,035, filed on Oct. 13, 2014.

(51) Int. Cl. H04N 5/445; H04N 21/431; G06F 3/0488; H04N 21/422; G06F 3/0484; G06F 3/0482

(52) U.S. Cl. CPC H04N 5/44591; G06F 3/04842; G06F 3/0482; G06F 3/0488; H04N 21/4222; H04N 21/42208; H04N 21/4221; H04N 21/42224; H04N 5/44543; H04N 21/4318; H04N 21/4316

(57) ABSTRACT

A method for controlling an electronic device with aid of user input back channel (UIBC), an associated apparatus, and an associated computer program product are provided, where the method includes the steps of: outputting video information of a UIBC user interface (UI) to an external display device, to display the UIBC UI on a display area of the external display device, wherein the external display device is positioned outside the electronic device; and receiving from a user of the electronic device through the external display device a user input applied to the UIBC UI, and controlling the electronic device to operate in response to the user input applied to the UIBC UI.

### CROSS REFERENCE TO RELATED APPLICATIONS

This application claims the benefit of U.S. Provisional Application No. 62/063,035, which was filed on Oct. 13, 2014, and is included herein by reference.

### BACKGROUND

The present disclosure relates to user control interface of an electronic device, such as the user control interface from another screen positioned outside the electronic device, and more particularly, to a method for controlling an electronic device with aid of user input back channel (UIBC), an associated apparatus, and an associated computer program product.

According to the related art, in a situation where a conventional electronic device such as a multifunctional mobile phone is casting some video contents to a conventional display device, for example, in a Wireless-Fidelity (Wi-Fi) Display mode, the user of the conventional electronic device may view the video contents from the conventional display device. Typically, the user may be familiar with some hardware keys of conventional electronic device, and may use these hardware keys to control the conventional electronic device while viewing the video contents from the conventional display device. However, some problems may occur. For example, when the user is holding a remote controller of the conventional display device, it seems unlikely that the user can use the remote controller of the conventional display device to utilize the hardware keys of the conventional electronic device, for controlling the conventional electronic device with the remote controller and viewing the video contents from the conventional display device at the same time. Thus, a novel method is required for improving the user control interface of an electronic device.

### SUMMARY

It is therefore an objective of the claimed disclosure to provide a method for controlling an electronic device with aid of user input back channel (UIBC), an associated apparatus, and an associated computer program product, in order to solve the above-mentioned problems.

It is another objective of the claimed disclosure to provide a method for controlling an electronic device with aid of UIBC, an associated apparatus, and an associated computer program product, in order to allow the user to have various options of controlling the electronic device while viewing from a large screen positioned outside the electronic device.

It is another objective of the claimed disclosure to provide a method for controlling an electronic device with aid of UIBC, an associated apparatus, and an associated computer program product, in order to provide the user with at least one UIBC floating button on a large display area of a large display device, such as one or more UIBC floating buttons emulating one or more hardware keys of the electronic device, for controlling the electronic device with a remote controller of the large display device and viewing some video contents of the electronic device from the large display device at the same time.

According to at least one preferred implementation, a method for controlling an electronic device with aid of UIBC is provided, where the method comprises the steps of: outputting video information of a UIBC user interface (UI) to an external display device, to display the UIBC UI on a display area of the external display device, wherein the external display device is positioned outside the electronic device; and receiving from a user of the electronic device through the external display device a user input applied to the UIBC UI, and controlling the electronic device to operate in response to the user input applied to the UIBC UI.

According to at least one preferred implementation, an apparatus for controlling an electronic device with aid of UIBC is provided, where the apparatus comprises at least one portion of the electronic device. The apparatus may comprise a transceiver and a processing circuit that is coupled to the transceiver. The transceiver may be arranged for transmitting or receiving information for the electronic device. In addition, the processing circuit may be arranged for outputting, through the transceiver, video information of a UIBC UI to an external display device, to display the UIBC UI on a display area of the external display device, receiving from a user of the electronic device through the external display device a user input applied to the UIBC UI, and controlling the electronic device to operate in response to the user input applied to the UIBC UI, wherein the external display device is positioned outside the electronic device.

According to at least one preferred implementation, a computer program product is provided, where the computer program product has program instructions for instructing a processing circuit of an electronic device to perform a method comprising the steps of: outputting video information of a UIBC UI to an external display device, to display the UIBC UI on a display area of the external display device, wherein the external display device is positioned outside the electronic device; and receiving from a user of the electronic device through the external display device a user input applied to the UIBC UI, and controlling the electronic device to operate in response to the user input applied to the UIBC UI.

It is an advantage of the present disclosure that the present disclosure method, the associated apparatus, and the associated computer program product can provide consistent, convenient, and efficient UI experience for end-users. In addition, the present disclosure method, the associated apparatus, and the associated computer program product allow the user to have various options of controlling the electronic device while viewing from a large screen positioned outside the electronic device. Additionally, the present disclosure method, the associated apparatus, and the associated computer program product provide the user with at least one UIBC floating button on a large display area of a large display device, such as one or more UIBC floating buttons emulating one or more hardware keys of the electronic device, for controlling the electronic device with a remote controller of the large display device and viewing some video contents of the electronic device from the large display device at the same time.

These and other objectives of the present disclosure will no doubt become obvious to those of ordinary skill in the art after reading the following detailed description of the preferred implementation that is illustrated in the various figures and drawings.

### BRIEF DESCRIPTION OF THE DRAWINGS

FIG. 1 is a diagram of an apparatus for controlling an electronic device with aid of user input back channel (UIBC) according to a first implementation of the present disclosure.

FIG. 2 illustrates a multifunctional mobile phone involved with the apparatus shown in FIG. 1 according to an implementation of the present disclosure, where an external display device is also illustrated for better comprehension.

FIG. 3 illustrates a flowchart of a method for controlling an electronic device with aid of UIBC according to an implementation of the present disclosure.

FIG. 4 illustrates a UIBC user interface (UI) control scheme involved with the method shown in FIG. 3 according to an implementation of the present disclosure.

FIG. 5 illustrates a UIBC UI control scheme involved with the method shown in FIG. 3 according to another implementation of the present disclosure.

FIG. 6 illustrates a remote rotate control scheme involved with the method shown in FIG. 3 according to an implementation of the present disclosure.

FIG. 7 illustrates a remote rotate control scheme involved with the method shown in FIG. 3 according to another implementation of the present disclosure.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

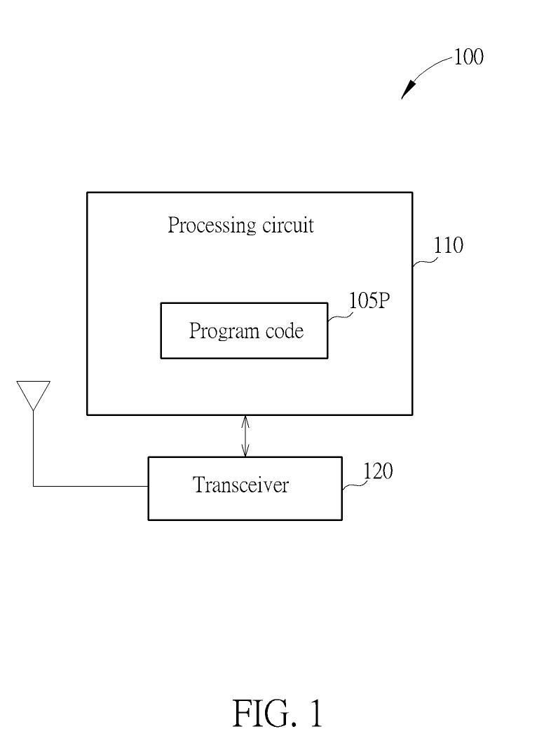

Please refer to FIG. 1, which illustrates a diagram of an apparatus 100 for controlling an electronic device with aid of user input back channel (UIBC) according to a first implementation of the present disclosure, where the apparatus 100 may comprise at least one portion (e.g. a portion or all) of the electronic device. For example, the apparatus 100 may comprise a portion of the electronic device mentioned above, and more particularly, can be at least one hardware circuit such as at least one integrated circuit (IC) within the electronic device. In another example, the apparatus 100 can be the whole of the electronic device mentioned above. In another example, the apparatus 100 may comprise a system comprising the electronic device mentioned above (e.g. an audio/video system comprising the electronic device). Examples of the electronic device may include, but not limited to, a mobile phone (e.g. a multifunctional mobile phone), a tablet, a wearable device and a personal computer such as a laptop computer.

As shown in FIG. 1, the apparatus 100 may comprise a processing circuit 110 which is capable of controlling one or more operations of the electronic device with aid of UIBC, and may further comprise a transceiver 120 capable of transmitting and/or receiving information for the electronic device, where the transceiver 120 is coupled to the processing circuit 110, and one or more antennas of the electronic device may be coupled to the transceiver 120. For example, the processing circuit 110 may execute program code 105P (e.g. program instructions), and more particularly, may comprise at least one processor (e.g. one or more processors) such as a computer processor for executing the program code 105P, and the transceiver 120 may comprise a transmitter and a receiver such as those for wireless network communications. Though the program code 105P is shown in FIG. 1 as contained in the processing circuit 110, it can be stored in any storage located anywhere that the processing circuit 110 can access.

In some examples, the operations of controlling one or more operations of the electronic device with aid of UIBC can be implemented with a specialized hardware circuit such as a customized IC, where the aforementioned specialized hardware circuit such as the customized IC mentioned above can be regarded as the processing circuit 110 of these examples.

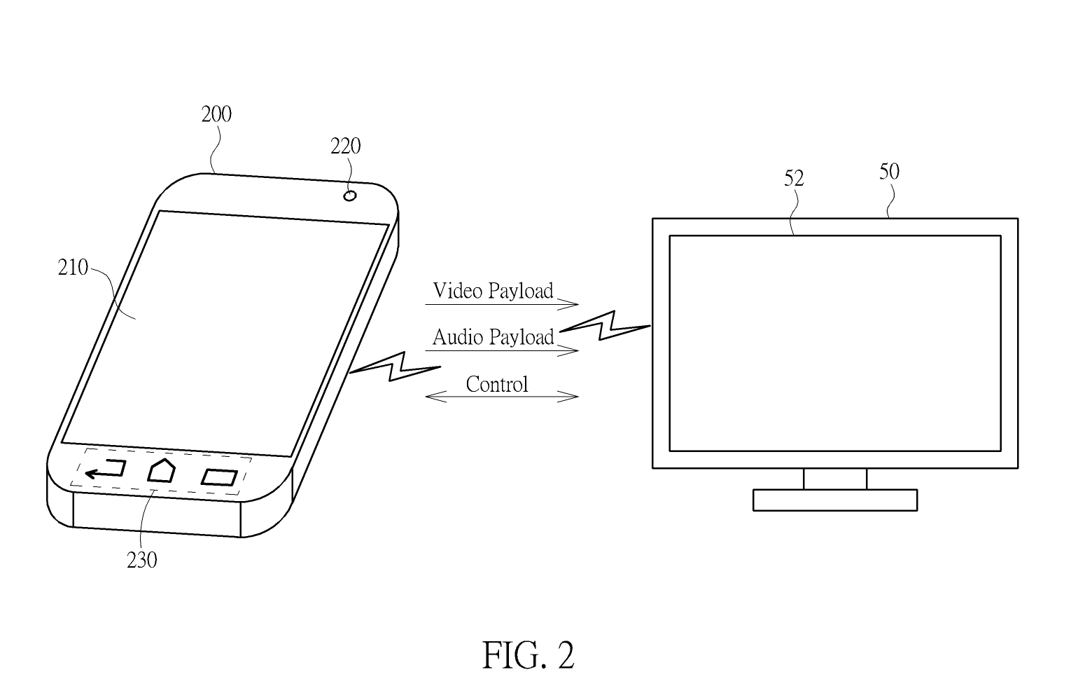

FIG. 2 illustrates a multifunctional mobile phone 200 involved with the apparatus 100 shown in FIG. 1 according to an implementation of the present disclosure, where an external display device 50 (e.g. a smart television (TV) device, or a monitor device equipped with a set-up box, etc. for performing similar operations) comprising a display area 52, which is typically greater than that of the multifunctional mobile phone 200, is also illustrated for better comprehension. The multifunctional mobile phone 200 can be taken as an example of the electronic device mentioned above.

As shown in FIG. 2, the multifunctional mobile phone 200 may comprise a touch sensitive display module 210 and a camera 220. Under control of a processor of the multifunctional mobile phone 200, such as the computer processor mentioned in the implementation shown in FIG. 1, the multifunctional mobile phone 200 may provide some virtual buttons and/or some virtual keys through the touch sensitive display module 210, such as some software (or software-based) keys within (or on) the touch sensitive display module 210. For example, the multifunctional mobile phone 200 may further comprise a plurality of hardware (or hardware-based) keys 230. In this implementation, the hardware keys 230 may be adjacent to the touch sensitive display module 210, and more particularly, may be positioned below the display area of the touch sensitive display module 210. This is for illustrative purposes only, and is not meant to be a limitation of the present disclosure. In some implementations, the hardware keys 230 may be positioned somewhere else, within the multifunctional mobile phone 200.

According to this implementation, the multifunctional mobile phone 200 and the external display device 50 may be implemented to have some Wireless-Fidelity (Wi-Fi) Display (WFD) features such as UIBC, where the multifunctional mobile phone 200 can be regarded as a WFD source and the external display device 50 can be regarded as a WFD sink. Some video payloads may be transmitted from the multifunctional mobile phone 200 to the external display device 50, for playing the associated video contents of the WFD source with the WFD sink correspondingly. In addition, some audio payloads (which may correspond to the video payload, for example) maybe transmitted from the multifunctional mobile phone 200 to the external display device 50, for playing the associated audio contents of the WFD source with the WFD sink correspondingly. Additionally, control information (labeled “Control” in FIG. 2, for brevity) may be transmitted between the multifunctional mobile phone 200 and the external display device 50, for carrying out the UIBC-based architecture of this implementation. For example, under control of the processor of the multifunctional mobile phone 200, such as the computer processor mentioned in the implementation shown in FIG. 1, the multifunctional mobile phone 200 may provide at least one UIBC floating button on the display area 52 of the external display device 50, such as one or more UIBC floating buttons emulating one or more hardware keys within the plurality of hardware keys 230, for controlling the multifunctional mobile phone 200 with a remote controller of the external display device 50 and viewing the video contents of the multifunctional mobile phone 200 from the external display device 50 at the same time. This is for illustrative purposes only, and is not meant to be a limitation of the present disclosure. In some implementations, the remote controller mentioned above may be replaced by another input module of the external display device 50, such as a touch screen of the external display device 50 (e.g. the display area 52 may be the display area of this touch screen) or a touch pad of the external display device 50, while the multifunctional mobile phone 200 may still provide the aforementioned at least one UIBC floating button on the display area 52 of the external display device 50.

In practice, input information of UIBC user inputs may be packed using a common packet header and transported through TCP/IP (which may be known as Transmission Control Protocol/Internet Protocol). The user input categories may include Generic and HIDC (which may be known as Human Interface Device Class).

According to some implementations, the multifunctional mobile phone 200 can be taken as an example of the electronic device mentioned above. This is for illustrative purposes only, and is not meant to be a limitation of the present disclosure. According to some implementations, any other electronic device (e.g. another type of electronic device, such as an electronic device that is not a multifunctional mobile phone) can be taken as an example of the electronic device mentioned above.

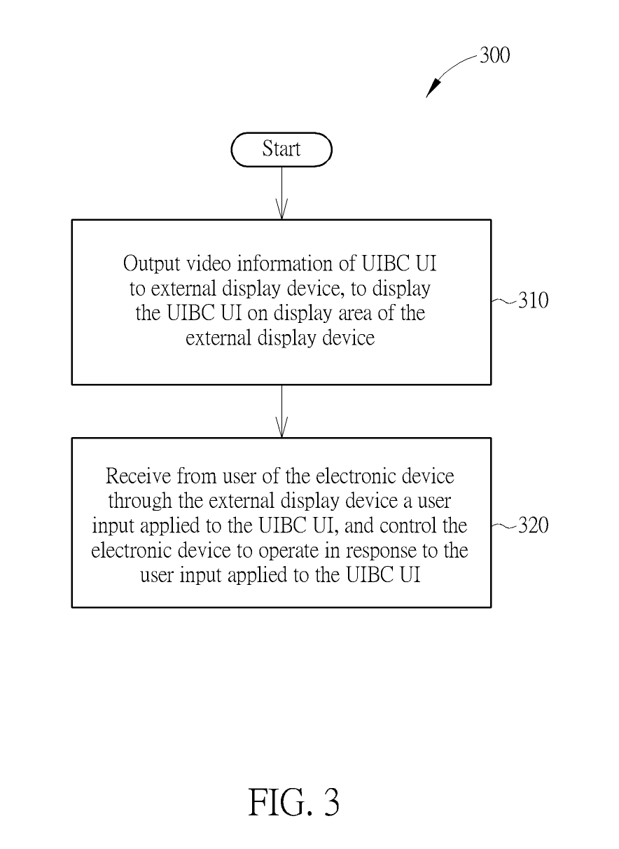

FIG. 3 illustrates a flowchart of a method 300 for controlling an electronic device with aid of UIBC according to an implementation of the present disclosure. The method 300 shown in FIG. 3 can be applied to the apparatus 100 shown in FIG. 1 (more particularly, the multifunctional mobile phone 200 of the implementation shown in FIG. 2), and can be applied to the processing circuit 110 executing the program code 105P. For example, the program code 105P may be provided through a computer program product having program instructions (such as those mentioned above) for instructing a processing circuit such as that mentioned above to perform the method 300 shown in FIG. 3 (or at least one portion of operations of the method 300, such as one or more operations of any of the control schemes in the subsequent implementations), where the computer program product may be implemented as a non-transitory computer-readable medium (e.g. a floppy disk or a compact disc-read only memory (CD-ROM)) storing the program instructions or an equivalent version thereof, such as a software package for being installed. This is for illustrative purposes only, and is not meant to be a limitation of the present disclosure. The method can be described as follows.

In Step 310, the processing circuit 110 may output, through the transceiver 120, video information of a UIBC user interface (UI) to the external display device 50, to display the UIBC UI on the display area 52 of the external display device 50, where the external display device 50 is positioned outside the electronic device. For example, the UIBC UI may comprise the aforementioned at least one UIBC floating button, for emulating at least one hardware (or hardware-based) key. As a result, the user may utilize the aforementioned at least one UIBC floating button as the replacement of the aforementioned at least one hardware key when needed.

In Step 320, the processing circuit 110 may receive from the user of the electronic device through the external display device 50 a user input applied to the UIBC UI, and may control the electronic device to operate in response to the user input applied to the UIBC UI. For example, in a situation where the UIBC UI comprises the aforementioned at least one UIBC floating button, when the user input is applied to a specific UIBC floating button within the aforementioned at least one UIBC floating button, the processing circuit 110 may control the electronic device to operate in response to the user input applied to the specific UIBC floating button.

According to some implementations, under control of the processing circuit 110, the UIBC UI may comprise a floating UI on the display area 52 of the external display device 50. More particularly, the aforementioned at least one UIBC floating button may be implemented as a portion of the floating UI, and the processing circuit 110 is capable of blending the aforementioned at least one UIBC floating button into the floating UI. No matter whether the processing circuit 110 blends the aforementioned at least one UIBC floating button into the floating UI or not, the floating UI can be movable on the display area 52 by the user. For example, the floating UI is arbitrarily movable by the user. In another example, the floating UI is arbitrarily movable by the user within a predetermined display region on the display area 52, where the predetermined display region may correspond to a display area of a touch sensitive display module of the electronic device, such as the display area of the touch sensitive display module 210.

According to some implementations, under control of the processing circuit 110, in addition to the floating UI, the UIBC UI may further comprise a drag down menu region and a plurality of software keys such as that mentioned above, where each of the drag down menu region and the plurality of software keys is different from the floating UI.

According to some implementations, when no user input has been applied to any region of the floating UI for a predetermined time period, the processing circuit 110 may control the floating UI to become transparent. For example, after the floating UI becomes transparent, the processing circuit 110 may control the floating UI to become non-transparent in response to another user input.

According to some implementations, the aforementioned at least one UIBC floating button may comprise one or a combination of a Home key, a Back key, a Power key, and a Camera key, which emulate the associated hardware (or hardware-based) Home, Back, Power, and Camera keys, respectively.

Based on the method 300, the electronic device such as the multifunctional mobile phone 200 may provide the floating buttons in a connected state of WFD, to co-work with the top application without any side-effect. As a result, the method 300, the associated apparatus 100, and the associated computer program product may provide consistent, convenient, and efficient UI experience for end-users. In addition, the method 300, the associated apparatus 100, and the associated computer program product may allow the user to have various options of controlling the electronic device while viewing from a large screen positioned outside the electronic device.

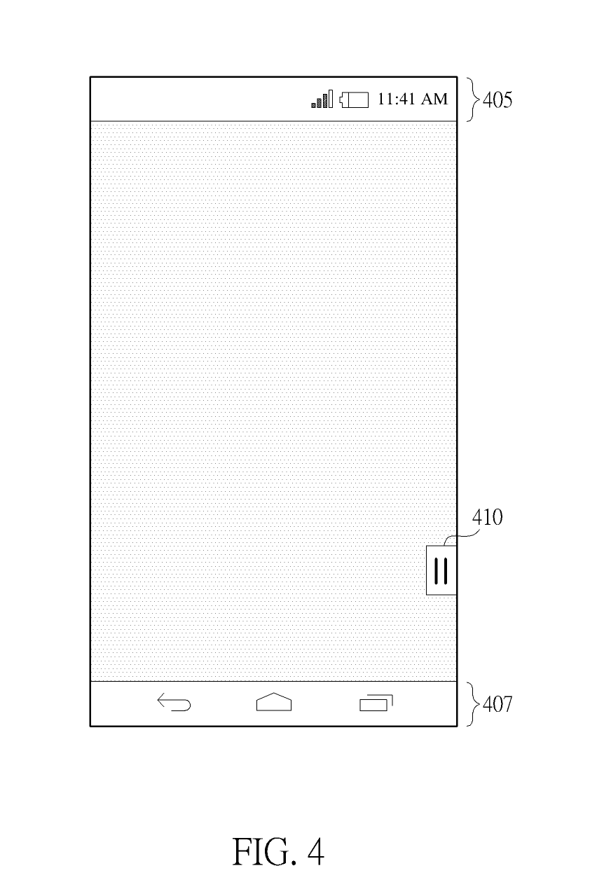

FIG. 4 illustrates a UIBC UI control scheme involved with the method 300 shown in FIG. 3 according to an implementation of the present disclosure, where the UIBC UI shown in FIG. 4 maybe displayed on the display area 52 of the external display device 50. For example, under control of the processing circuit 110, this UIBC UI may comprise the drag down menu region 405 and the software keys 407, and may further comprise a floating UI 410, which can be taken as an example of the floating UI mentioned in some implementations described above. In addition, the floating UI 410 is moveable on the display area 52 by the user (e.g. the floating UI 410 may be moved, dragged, or dropped on the display area 52 by the user), and therefore may be regarded as floating on the display area 52. For example, the floating UI 410 is arbitrarily movable by the user (e.g. the floating UI 410 may be moved, dragged, or dropped arbitrarily on the display area 52 by the user). In some examples, the floating UI 410 is arbitrarily movable within a predetermined display region on the display area 52, such as the predetermined display region mentioned in some implementations described above, by the user (e.g. the floating UI 410 may be moved, dragged, or dropped arbitrarily within the predetermined display region on the display area 52 by the user).

According to this implementation, the aforementioned at least one UIBC floating button may be hidden into the floating UI 410, and maybe available in an expanded version of the floating UI 410. Under control of the processing circuit 110, in response to a user input applied to a specific region of the floating UI 410 (e.g. a region having a specific texture or pattern, such as that around the left side of the floating UI 410 in this implementation), the floating UI 410 may be changed to the expanded version thereof. For example, when no user input has been applied to any region of the floating UI 410 for a predetermined time period (e.g. three seconds, or another length of time), the processing circuit 110 may control the floating UI 410 to become transparent. After the floating UI 410 becomes transparent, the processing circuit 110 may control the floating UI 410 to become non-transparent in response to another user input. For brevity, similar descriptions for this implementation are not repeated in detail here.

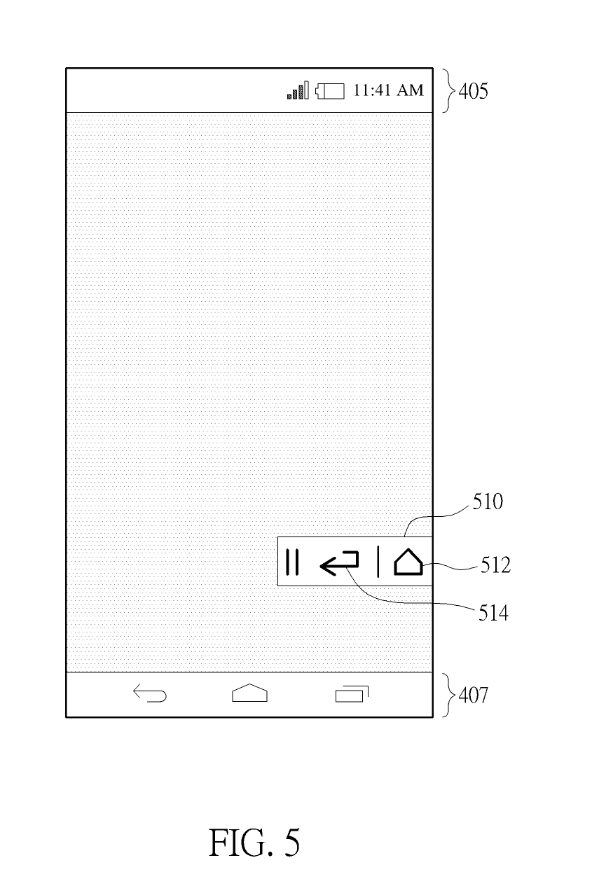

FIG. 5 illustrates a UIBC UI control scheme involved with the method 300 shown in FIG. 3 according to another implementation of the present disclosure, where the UIBC UI shown in FIG. 5 may be displayed on the display area 52 of the external display device 50. For example, under control of the processing circuit 110, this UIBC UI may comprise the drag down menu region 405 and the plurality of software keys 407 shown in FIG. 4, and may further comprise a floating UI 510, which can be taken as an example of the floating UI mentioned in some implementations described above. Please note that the floating UI 510 can also be taken as an example of the aforementioned expanded version of the floating UI 410 shown in FIG. 4. In addition, the floating UI 510 is moveable on the display area 52 by the user (e.g. the floating UI 510 may be moved, dragged, or dropped on the display area 52 by the user), and therefore may be regarded as floating on the display area 52. For example, the floating UI 510 is arbitrarily movable by the user (e.g. the floating UI 510 may be moved, dragged, or dropped arbitrarily on the display area 52 by the user). In some examples, the floating UI 510 is arbitrarily movable within a predetermined display region on the display area 52, such as the predetermined display region mentioned in some implementations described above, by the user (e.g. the floating UI 510 may be moved, dragged, or dropped arbitrarily within the predetermined display region on the display area 52 by the user).

According to this implementation, the aforementioned at least one UIBC floating button, such as the UIBC floating button 512 (e.g. a Home key) and the UIBC floating button 514 (e.g. a Back key), may be available in the floating UI 510. Under control of the processing circuit 110, in response to a user input applied to a specific region of the floating UI 510 (e.g. a region having a specific texture or pattern, such as that around the left side of the floating UI 510 in this implementation), the floating UI 510 may be changed to the collapsed version thereof, such as the floating UI 410 shown in FIG. 4. For example, when no user input has been applied to any region of the floating UI 510 for a predetermined time period (e.g. three seconds, or another length of time), the processing circuit 110 may control the floating UI 510 to become transparent. After the floating UI 510 becomes transparent, the processing circuit 110 may control the floating UI 510 to become non-transparent in response to another user input. For brevity, similar descriptions for this implementation are not repeated in detail here.

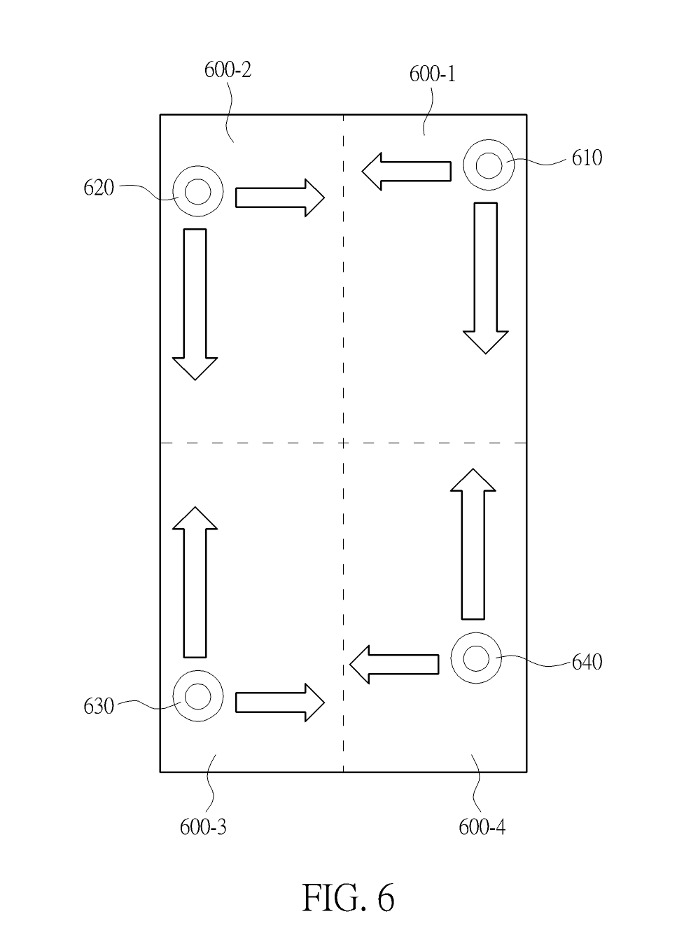

FIG. 6 illustrates a remote rotate control scheme involved with the method 300 shown in FIG. 3 according to an implementation of the present disclosure. For example, the external display device 50 of this implementation may be equipped with a touch detection module. In addition, by analyzing the user input received through the touch detection module, the processing circuit 110 is capable of detecting at least one user gesture (e.g. one or more user gestures) of the user with aid of the touch detection module. Additionally, the processing circuit 110 is capable of controlling the video contents on the display area 52 to rotate clockwise or counterclockwise in response to the aforementioned at least one user gesture.

Ina situation where the touch detection module is implemented as a touch screen such as that mentioned above, the display area 52 of the external display device 50 may be equivalent to the display area of this touch screen. For example, the touch detection module may comprise a plurality of predetermined touch detection regions, for detecting the aforementioned at least one user gesture of the user. As a result of implementing the touch detection module as the touch screen, the plurality of predetermined touch detection regions may be positioned on the display area 52. This is for illustrative purposes only, and is not meant to be a limitation of the present disclosure. According to some implementations, in a situation where the touch detection module is implemented as a touch pad such as that mentioned above, the plurality of predetermined touch detection regions may be positioned on the touch pad.

As shown in FIG. 6, the whole of the display area 52 or the aforementioned predetermined display region on the display area 52 maybe divided into four regions 600-1, 600-2, 600-3, and 600-4 (e.g. four quarters thereof), where the four regions 600-1, 600-2, 600-3, and 600-4 can be taken as an example of the plurality of predetermined touch detection regions. According to this implementation, when it is detected that the user touches a partial region within a predetermined touch detection region of the plurality of predetermined touch detection regions, such as one of the four regions 600-1, 600-2, 600-3, and 600-4, and slides to a predetermined direction of a plurality of predetermined directions associated to this predetermined touch detection region (e.g. the aforementioned one of the four regions 600-1, 600-2, 600-3, and 600-4), the processing circuit 110 may control the video contents on the display area 52 to rotate clockwise or counterclockwise in response to the predetermined direction.

For example, when it is detected that the user touches a partial region 610 within the region 600-1 (e.g. by using one finger of the user) and slides (e.g. this finger) downward, the processing circuit 110 may control the video contents on the display area 52 to rotate clockwise. When it is detected that the user touches the partial region 610 within the region 600-1 (e.g. by using one finger of the user) and slides (e.g. this finger) leftward, the processing circuit 110 may control the video contents on the display area 52 to rotate counterclockwise. In addition, when it is detected that the user touches a partial region 620 within the region 600-2 (e.g. by using one finger of the user) and slides (e.g. this finger) downward, the processing circuit 110 may control the video contents on the display area 52 to rotate counterclockwise. When it is detected that the user touches the partial region 620 within the region 600-2 (e.g. by using one finger of the user) and slides (e.g. this finger) rightward, the processing circuit 110 may control the video contents on the display area 52 to rotate clockwise. Additionally, when it is detected that the user touches a partial region 630 within the region 600-3 (e.g. by using one finger of the user) and slides (e.g. this finger) upward, the processing circuit 110 may control the video contents on the display area 52 to rotate clockwise. When it is detected that the user touches the partial region 630 within the region 600-3 (e.g. by using one finger of the user) and slides (e.g. this finger) rightward, the processing circuit 110 may control the video contents on the display area 52 to rotate counterclockwise. Further, when it is detected that the user touches a partial region 640 within the region 600-4 (e.g. by using one finger of the user) and slides (e.g. this finger) upward, the processing circuit 110 may control the video contents on the display area 52 to rotate counterclockwise. When it is detected that the user touches the partial region 640 within the region 600-4 (e.g. by using one finger of the user) and slides (e.g. this finger) leftward, the processing circuit 110 may control the video contents on the display area 52 to rotate clockwise.

As mentioned above, the external display device 50 of this implementation may be equipped with the touch screen. This is for illustrative purposes only, and is not meant to be a limitation of the present disclosure. In some implementations, the external display device 50 may be equipped with a touch pad such as that mentioned above. In addition, the touch pad may be divided into four regions (e.g. four quarters thereof) such as the four regions 600-1, 600-2, 600-3, and 600-4 shown in FIG. 6. Based on similar user gesture detection operations that the processing circuit 110 performs by using the touch pad, the processing circuit 110 may control the video contents on the display area 52 to rotate clockwise or counterclockwise correspondingly as described above. For brevity, similar descriptions for these implementations are not repeated in detail here.

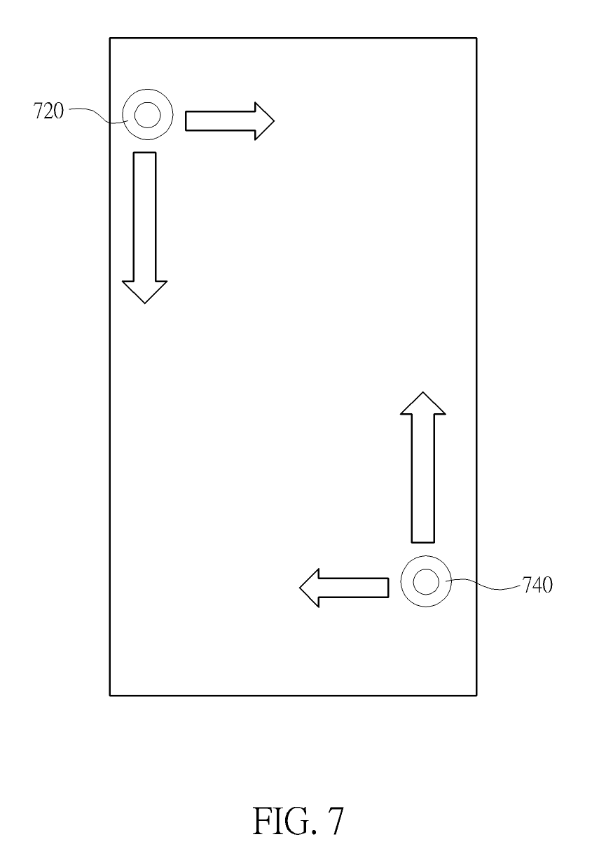

FIG. 7 illustrates a remote rotate control scheme involved with the method 300 shown in FIG. 3 according to another implementation of the present disclosure. For example, the external display device 50 of this implementation may be equipped with the touch detection module mentioned in the implementation shown in FIG. 7. In a situation where the touch detection module is implemented as a touch screen such as that mentioned above, the display area 52 of the external display device 50 maybe equivalent to the display area of this touch screen.

As shown in FIG. 7, at least two partial regions (e.g. two or more partial regions) such as the partial regions 720 and 740 may be involved during the user gesture detection operations performed by the processing circuit 110. No matter whether the whole of the display area 52 or the aforementioned predetermined display region on the display area 52 may be divided into multiple regions such as the aforementioned four regions 600-1, 600-2, 600-3, and 600-4 (e.g. the four quarters thereof) or not, the processing circuit 110 is capable of detecting the aforementioned at least one user gesture of the user with aid of the touch detection module. According to this implementation, when it is detected that the user touches any two partial regions in the whole of the display area 52 or in the aforementioned predetermined display region on the display area 52 (e.g. by using two fingers of the user) and slides (e.g. these two fingers) clockwise, the processing circuit 110 may control the video contents on the display area 52 to rotate clockwise. When it is detected that the user touches any two partial regions in the whole of the display area 52 or in the aforementioned predetermined display region on the display area 52 (e.g. by using two fingers of the user) and slides (e.g. these two fingers) counterclockwise, the processing circuit 110 may control the video contents on the display area 52 to rotate counterclockwise. For example, when it is detected that the user touches the partial region 720 (e.g. by using one of his/her fingers) and slides (e.g. the one of his/her fingers) rightward and further touches the partial region 740 (e.g. by using another one of his/her fingers) and slides (e.g. the other one of his/her fingers) leftward, the processing circuit 110 may control the video contents on the display area 52 to rotate clockwise. When it is detected that the user touches the partial region 720 (e.g. by using one of his/her fingers) and slides (e.g. the one of his/her fingers) downward and further touches the partial region 740 (e.g. by using another one of his/her fingers) and slides (e.g. the other one of his/her fingers) upward, the processing circuit 110 may control the video contents on the display area 52 to rotate counterclockwise.

As mentioned above, the external display device 50 of this implementation may be equipped with the touch screen. This is for illustrative purposes only, and is not meant to be a limitation of the present disclosure. In some implementations, the external display device 50 may be equipped with a touch pad such as that mentioned above. In addition, based on similar user gesture detection operations that the processing circuit 110 performs by using the touch pad, the processing circuit 110 may control the video contents on the display area 52 to rotate clockwise or counterclockwise correspondingly as described above. For brevity, similar descriptions for these implementations are not repeated in detail here.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A method for controlling an electronic device with aid of user input back channel (UIBC), the method comprising the steps of:
outputting video information of a UIBC user interface (UI) to an external display device, to display the UIBC UI on a display area of the external display device, wherein the external display device is positioned outside the electronic device; and
receiving from a user of the electronic device through the external display device a user input applied to the UIBC UI, and controlling the electronic device to operate in response to the user input applied to the UIBC UI.

2. The method of claim 1, wherein the UIBC UI comprises at least one UIBC floating button, for emulating at least one hardware key of the electronic device.

3. The method of claim 1, wherein the UIBC UI comprises at least one UIBC floating button; and the step of receiving from the user of the electronic device through the external display device the user input applied to the UIBC UI and controlling the electronic device to operate in response to the user input applied to the UIBC UI further comprises:
when the user input is applied to a specific UIBC floating button within the at least one UIBC floating button, controlling the electronic device to operate in response to the user input applied to the specific UIBC floating button.

4. The method of claim 1, wherein the UIBC UI comprises a floating UI on the display area of the external display device.

5. The method of claim 4, wherein the floating UI is movable on the display area by the user.

6. The method of claim 5, wherein the floating UI is arbitrarily movable within a predetermined display region on the display area by the user, wherein the predetermined display region corresponds to a display area of a touch sensitive display module of the electronic device.

7. The method of claim 4, wherein the UIBC UI further comprises a drag down menu region and a plurality of software keys, and each of the drag down menu region and the plurality of software keys is different from the floating UI.

8. The method of claim 4, further comprising:
when no user input has been applied to any region of the floating UI for a predetermined time period, controlling the floating UI to become transparent.

9. The method of claim 8, further comprising:
after the floating UI becomes transparent, controlling the floating UI to become non-transparent in response to another user input.

10. A computer program product, having program instructions for instructing a processing circuit of an electronic device to perform a method comprising the steps of:
outputting video information of a user input back channel (UIBC) user interface (UI) to an external display device, to display the UIBC UI on a display area of the external display device, wherein the external display device is positioned outside the electronic device; and
receiving from a user of the electronic device through the external display device a user input applied to the UIBC UI, and controlling the electronic device to operate in response to the user input applied to the UIBC UI.

11. An apparatus for controlling an electronic device with aid of user input back channel (UIBC), the apparatus comprising at least one portion of the electronic device, the apparatus comprising:
a transceiver, arranged for transmitting or receiving information for the electronic device; and
a processing circuit, coupled to the transceiver, arranged for outputting, through the transceiver, video information of a UIBC user interface (UI) to an external display device, to display the UIBC UI on a display area of the external display device, receiving from a user of the electronic device through the external display device a user input applied to the UIBC UI, and controlling the electronic device to operate in response to the user input applied to the UIBC UI, wherein the external display device is positioned outside the electronic device.

12. The apparatus of claim 11, wherein the UIBC UI comprises at least one UIBC floating button, for emulating at least one hardware key of the electronic device.

13. The apparatus of claim 11, wherein the UIBC UI comprises at least one UIBC floating button; and when the user input is applied to a specific UIBC floating button within the at least one UIBC floating button, the processing circuit controls the electronic device to operate in response to the user input applied to the specific UIBC floating button.

14. The apparatus of claim 11, wherein under control of the processing circuit, the UIBC UI comprises a floating UI on the display area of the external display device.

15. The apparatus of claim 14, wherein the floating UI is movable on the display area by the user.

16. The apparatus of claim 15, wherein the floating UI is arbitrarily movable within a predetermined display region on the display area by the user, wherein the predetermined display region corresponds to a display area of a touch sensitive display module of the electronic device.

17. The apparatus of claim 14, wherein under control of the processing circuit, the UIBC UI further comprises a drag down menu region and a plurality of software keys, and each of the drag down menu region and the plurality of software keys is different from the floating UI.

18. The apparatus of claim 14, wherein when no user input has been applied to any region of the floating UI for a predetermined time period, the processing circuit controls the floating UI to become transparent.

19. The apparatus of claim 18, wherein after the floating UI becomes transparent, the processing circuit controls the floating UI to become non-transparent in response to another user input.

20. The apparatus of claim 11, wherein the external display device is equipped with a touch detection module, and the processing circuit detects at least one user gesture of the user with aid of the touch detection module; and the processing circuit controls video contents on the display area to rotate clockwise or counterclockwise in response to the at least one user gesture.
